(19) United States
(12) Patent Application Publication
(10) Pub. No.: US 2016/0314213 A1
(43) Pub. Date: Oct. 27, 2016

(54) METHOD AND SYSTEM FOR CHARACTERIZING A USER GROUP

(71) Applicant: TELEFONICA DIGITAL ESPAÑA, S.L.U., Madrid (ES)

(72) Inventors: Ana Armenta Lopez de Vicuña, Madrid (ES); Arturo Canales Gonzalez, Madrid (ES); Rafael Pellón Gómez-Calcerrada, Madrid (ES); Patricia Calvo Carrasco, Madrid (ES); Susana Ferreras de la Fuente, Madrid (ES)

(21) Appl. No.: 15/102,770

(22) PCT Filed: Dec. 9, 2013
(86) PCT No.: PCT/ES2013/070857

§ 371 Date: Jun. 8, 2016

(51) Int. Cl. G06F 17/30; H04L 29/08

(52) U.S. Cl. CPC G06F 17/30867; G06F 17/30958; G06F 17/3053; G06F 17/30598; H04L 67/02; H04L 67/306

(57) ABSTRACT

The present invention refers to a method for characterizing a group of users, related among them by their mobile communication data, according to web navigation data. The method comprises: building a social graph from the mobile communication data of a user and his contacts; extracting web navigation data of each user of the social graph; associating to each edge linking two users of the social graph, web navigation data extracted for both two users; obtaining a measure of harmony based on comparing web navigation data of both two users; and providing a set of metrics for the group of users based on the measures of harmony, characterizing the group of users.

### TECHNICAL FIELD OF THE INVENTION

Present invention generally relates to the use of Internet, web navigation data and mobile communications of users associated among them in order to characterize different groups of users and interests shared by them.

### BACKGROUND OF THE INVENTION

Nowadays, the study of social networks and the relationships among their users are at their peak. The growth that are experimenting in modern society, make them becoming a key technique with impact in every field.

Although social network analysis (SNA) is commonly tied to online networks (as Facebook or LinkedIn), associations can be done based on multiple type of relationships. For example these networks may be built according to the mobile usage among their members. SNA is characterized by graphs: nodes that represent participants and links or edges that show the presence and intensity of the social interaction.

The individual web profiling has also been an issue of interest in the prior art. Individual interests for customers who use web navigation may be useful to approach the main features in their profiles. Some data referring to web content are extracted by means of different algorithms classifying interests according to the extracted data.

The relationship among the users may be useful for profiling purposes. Then, groups or communities sharing some features are interesting to be found. Community detection in massive social networks is already solved in the prior art. The application WO 2012004425 A1, from 2010, explains the concept of community detection with a cumulative approach. It uses a flexible and efficient method for detecting overlapping communities, since an individual may have different social circles. According to this, communities will be constructed iteratively, from basic groups to high-level communities until the algorithm converges.

However, finding cohesive communities of interest, with members closely related, is a complex problem which there is not a proper solution yet, because existing alternatives are too weak and present some gaps.

On one hand, SNA algorithms are prepared to obtain groups of individuals with high relation between them but not very homogeneous in terms of age, status, interests . . . . This will make more difficult to use these communities in targeted actions due to the differences in their characteristics.

By the other hand, communities created from web navigation are developed from a common interest in a specific domain or group of domains, as it is learned from the document “Dynamic online communities” US 20120158637 A1, 2012. Using this approach, it is possible to build groups that share interests but they may be totally disconnected, having no relationship among members. It will difficult a lot the spread of the information through the network and, depending on the purpose, the groups may be almost useless.

Community profiling and the characterization of groups of users is usually addressed from a single point of view, becoming a restricted solution in a very specific situation. Thus, community profiling just based on web navigation shows some gaps because it can create very homogeneous communities with common interests, but this communities will not be formed by close people. In the other hand, there have also been created communities based on closeness and relations among people who has not common interests at all.

For all the reasons exposed before, it is missing in the prior art a method coming to solve this situation with the construction of singular communities, made by individuals related among them and who also share common interests.

### SUMMARY OF THE INVENTION

Present invention solves the aforementioned problems improving the community creation process based on social interactions and characterizing it with the web browsing behavior within the community. For a given “phone usage community” (understanding a community as a group of users related among them by their mobile communications), present invention assumes that it might be interesting to know the different kind of browsing interests present in the group of users, even if the group is not homogeneous in terms of interests, as that browsing interest heterogeneity provides really valuable information.

The browsing interest distribution for a phone usage community could only be computed once the phone and online behaviors merge. Existing solutions are focused on building communities or profiling them, but not in creating groups based on phone-call interaction and profiling them in terms of the community web browsing behavior. So, it is presented a method for characterizing a group of users, related among them by their mobile communication data, according to web navigation data. The method comprises:
a) building a social graph from the mobile communication data of a user and his contacts;
b) extracting web navigation data of each user of the social graph;
c) associating to each edge linking two users of the social graph, web navigation data extracted for both two users;
d) obtaining a measure of harmony based on comparing web navigation data of both two users;
e) providing a set of metrics for the group of users based on the measures of harmony of step e), characterizing the group of users.

The mobile communications data of a user may be obtained from the call detail records of said user. Call detailed records are used in some embodiments for weighting a relation between two users of the social graph. It is a possible implementation for taking into account social interactions based on mobile communications (calls, SMS, MMS . . . ) when building dyads (group of two nodes with an edge between them) and communities or group of users.

In one embodiment of the invention, the web navigation data of a user refer to categories of web content visited by said user.

Web navigation data of users may be obtained from provided profiles of the users. From all the information that may be gathered from a web profile of a user, the interest in certain web contents of website visited by the user is obtained to be ranked in different levels. The categories are previously set in a web content dictionary.

Optionally, the step of comparing categories between two users may further comprise defining a comparison function to rank the level of harmony between nodes:
assigning a weight distribution according to the subcategories of each category;
comparing each subcategory of the two users;
providing a value of harmony as a result of the comparison: if two subcategories match, their weights are added; if they are different, their weights are subtracted; and if there is no correspondence for a subcategory in one user, the weight are ignored.

In the same way that SNA algorithms may be applied recursively to build communities from edges, the comparison function may be applied in some embodiments of the invention to extend dyads with similar users, so communities or group of users are properly constructed.

Additionally, when calculating the measure of harmony, the number of categories involved for each user may be taken into account, which may result in a different measure from a user A to a user B than from the user B to the user A. At the end, both of them are combined to offer a global measure for the relation among users A and B.

When profiling communities, or characterizing groups of users related among them, it may comprised at least one of the following metrics: number of users, number of users who browse the Internet, number of users who browse certain websites and a homogeneity degree of users belonging to the group.

The users may belong to more than one group in some embodiments of the invention.

The users may be users of a social network, further comprising using social network analysis for determining groups of users, according to one embodiment of the invention.

A second aspect of the invention refers to a system for characterizing a group of users, related among them by their mobile communication data, according to web navigation data. The system is characterized by comprising means for building a social graph from the mobile communication data of a user and his contacts; means for extracting web navigation data of each user of the social graph; means for associating to each edge linking two users of the social graph, web navigation data extracted for both two users; means for obtaining a measure of harmony based on comparing web navigation data of both users; and means for providing a set of metrics for the groups of users based on the measures of harmony of step e), characterizing the group of users.

A last aspect of the invention refers to a computer program product comprising computer program code adapted to perform the method of the invention when said program code is executed on a computer, a digital signal processor, a field-programmable gate array, an application-specific integrated circuit, a micro-processor, a micro-controller, or any other form of programmable hardware.

Existing solutions around the creation of communities just focus on one aspect, either communities with customers who socially interact or communities with common interests but not known relation between them. Present invention, joining both SNA and Webprofiling pieces gets a more precise and complete definition about the content. On one side, communities obtained from mobile communications form cohesive groups of members related among them. By the other side, the creation of interests from web navigation complements the characterization of the groups without any inference in adding or excluding nodes, just characterizing them. This avoid the problem of creating cohesive groups—in closeness or in interests—but “unreal” in the sense that they are based in one aspect, instead of multiple views.

Efficiency in community definition is significantly increased but computational cost does not suffer important effects because both input processes have been optimized and already calculated.

### DESCRIPTION OF THE DRAWINGS

To complete the description that is being made and with the object of assisting in a better understanding of the characteristics of the invention, in accordance with a preferred example of practical embodiment thereof, accompanying said description as an integral part thereof, is a set of drawings wherein, by way of illustration and not restrictively, the following has been represented:

FIG. 1.—shows a block diagram of one embodiment of the invention.

FIG. 2.—shows a diagram comparing web categories according to one embodiment of the invention.

### DETAILED DESCRIPTION OF THE INVENTION

The invention describes a process for, in general terms, characterizing groups of users (profiling communities) based on social interactions and taking into account the web browsing behavior.

Social interactions—based on mobile communications (for example calls, SMS, MMS . . . )—are taken into consideration when building the groups and may even be used to quantify weights for the relations between users.

Individual interests per user are important for proposed invention. They are obtained from web navigation data and a categorization of webpages. Once the users are categorized, the process extends to links to compare if two nodes are sharing common interests, which result in a common profile for this dyad. Then, a comparison function would be applied to rank the level of harmony or similarity (terms “harmony” and “similarity” can be replaced one with the other along this document for the sake of clarity) between nodes. In the same way that social network analysis algorithm is applied recursively to build communities from edges or links, the comparison function would be applied here to extend dyads with similar nodes, so communities are properly constructed.

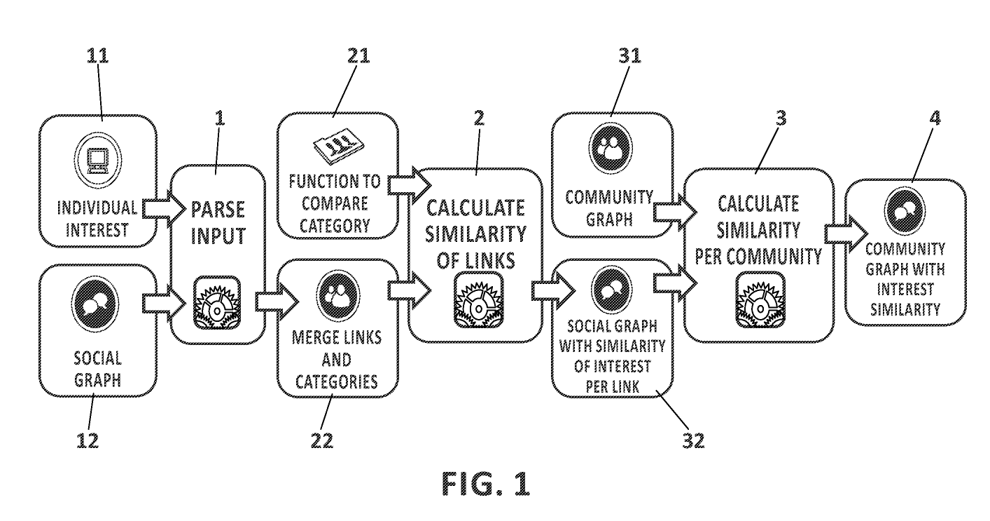

FIG. 1 represents a scheme of the proposed invention according to one particular embodiment. Two different inputs are considered to be parsed in this embodiment: individual interest of users and a social graph.
Individual interests (11): available web profiles of users are taken as an input. Any of the method proposed in the prior art may provide said user profiles. A user profile reflects the interests of the users based on their web browsing behavior. It can be taken for example, from the web logs and, based on some dictionary of categories which determines for each website what group it belongs to, computing interest profiles as a ranking of visits per user and category of web content.
A nonexclusive example of the implementation of the individual interest profile is described by means of the following table, where optional fields are included, but the main interest is focused on the field “Category”, which classify the web pages visited by a user according to a dictionary of categories:

| Name | Description |
|---|---|
| User ID | It can be for example MSISDN, internal |
| | Subscriber ID or Client IP. |
| Category | The category for the URL |
| Cat Level | The category level in the hierarchical |
| | structure of the dictionary |
| Interval | It can be for example day, week, month, |
| | day of week and time slot |
| Page Views | Number of viewed pages |
| Duration | Time spent visiting URLs of that category, |
| | for example in seconds |
| Rank | User interest grade, for example: High, |
| | Medium or Low |

Social graph: (12): the other input of this embodiment refers to a social graph. The social graph is built with the social network of mobile users and their contacts based on traffic information extracted from the call detail records (CDR's) and some basic commercial information. Present invention does not regard to the construction of the social graph as it has already been disclosed in the prior art, so present invention takes advantage of the social graph and the groups of users (communities) involved.
For example, the social graphs may be built based on a number of files with information from monthly CDRS and list of clients. For example, it could be comprised a specific case where 3 data sources should be needed, one for each type of traffic: CDR's of voice calls, SMS and MMS. It would be run periodically.
For every pair of users for which a social relationship exists, the following output is generated according to one particular embodiment:

| Name | Description |
|---|---|
| MSISDN1 | Customer or non-customer |
| MSISDN2 | Customer or non-customer |
| Weight | Measuring the strength of the relationship, for |
| | example in terms of number of communications |
| | per month |
| Directionality | Measuring in which direction the communication |
| | is stronger |

Input parser (1): the two inputs of this particular embodiment (individual interests and social graph) are parsed and joined to provide the merged information as an output. The output of the input parser in this particular embodiment, results in a set of categories in which each of the nodes has a certain level of interest. Given two users defined for example as MSISDN1 and MSISDN2, the generated output would be like the following:

| Name | Description |
|---|---|
| MSISDN1, MSISDN2, Weight, | Information social graph |
| Directionality | |
| [Categories1], [Categories2] | All categories of the two phones |

Now the social links are characterized (22) by the categories of interest for the users, a comparing function is defined to be used for the interest harmony (2) computation:
Function to compare categories (21): providing a measure of the harmony between two users, referring to their categories, requires defining a comparing function. In this embodiment, the output value for this function may vary from 0 to 1. For example, if it is assumed that categories may have 5 levels, the weight distribution would be as follows:

$$Function = ( ( 1 , ) , ( 0.6 , 0.4 ) , ( 0.6 , 0.25 , 0.15 ) , ( 0.6 , 0.25 , 0.10 , 0.05 ) , ( 0.6 , 0.25 , 0.10 , 0.03 , 0.02 ) )$$

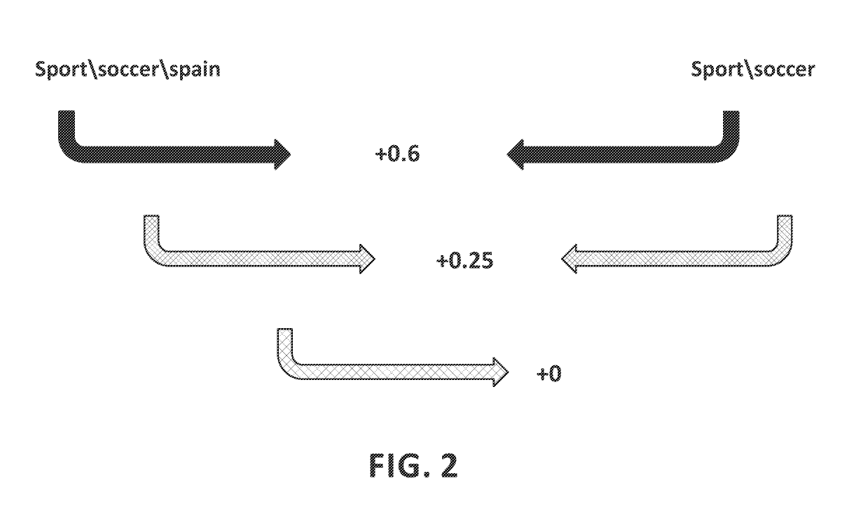

Then, for every pair of users (assuming one user corresponds to one phone) and their categories, the categories are compared one to one. In every category comparison, the highest subcategory or level is extracted and the values are assigned according to it. Once this is obtained, each subcategory is compared:
   If the subcategory of both users match, the value is added;
   If there is no subcategory/level in one side, nothing happens;
   If both subcategories/levels are different, the value is subtracted.
For example, if one wants to compare the categories Sports\soccer\spain and Sports\soccer, as it is graphically represented in FIG. 2, first category has three levels while the second one has only two, so there is a level-3 comparison and, following with the example, the level-3 values: [0.6, 0.25 and 0.15] should be used.
The interest harmony is then: 0.6+0.25=0.85.
Another example would be if the second telephone had had a third level called ‘spain’, so it would have matched and the interest harmony value would have been: 0.6+0.25+0.15=1
Following with the example, if its third level had been different, (‘bayern’), third value would have been subtracted: 0.6+0.25−0.15=0.7

For every link it is computed at least one measure of harmony, but in some embodiments a second measure is provided because the case of asymmetric measures is considered. The interest similarity from phone A to phone B and the interest similarity from B to A may be different. These values are single values per user and they can be different because they take into account the total number of interests per user to normalize and give a weighted value according to the number of interests. A more complex similarity value will be calculated merging these two single measures.

The output (32) which is obtained in this stage is the pair or telephones (also called edge or link) with two harmony measures, from 1 to 2 and from 2 to 1. These values depend on the number of categories for each phone and they also depend on the final value for the comparison function. For every edge with some social relationship, the following output is generated according to one possible embodiment of the invention:

| Name | Description |
|---|---|
| MSISDN1, MSISDN2 | Edges |
| Weight, Directionality, | Information from social graph, |
| Similarity12, Similarity21, | all categories the phones |
| {Cat11: value, Cat12: value, . . . } | belong to and the value of the |
| {Cat21: value, Cat22: value, . . . } | comparison function |

The output (32) of previous stage is actually one of the inputs for the final stage of calculating the harmony per community (3). The other input is a community graph (31) which involves all the social communities which users belong to. These communities or groups of users are detected in a previous step and are already built by solutions from the prior art. These groups obtained as output may include users served by different operators because they may have some social relation regardless of the operator. Starting from the analysis of the communication between MSISDNs, links are created between them and then, using some agglomerative algorithm from prior art (for example WO 2012004425 A1), communities of related MSISDNs are obtained. For every phone number and the group of users or community it belongs to, the following output is generated according to one embodiment of the invention:

| Name | Description |
|---|---|
| MSISDN | Customer or non-customer |
| Id_com | Community Id. the user belongs to |
| Num_total | Membership strength, indicating |
| | whether the MSISDN is a strong |
| | member of the community |
| | according to its communications. |

Thus, the previous stage has provided an interest harmony measure in every pair of related users. Extending this to the communities, some metrics are obtained that indicate how similar the users of a community are. Extracting the distribution of values of interest for every group of users and these metrics, the homogeneity degree within the community is described in terms of harmony between categories.

These metrics, as the number of members or the number of members who browse websites, quantify interesting features about the group of users. Thus, it is not needed an individual in-depth study to extract the relevant information, but this information is easily appreciable and measurable in terms of numeric variables.

Also, it can be considered, according to one embodiment of the invention, a community as a set of nodes which are connected among them with a specific measure of harmony. Thus, some community metrics are calculated based on the set of harmony values of the clients belonging to that community:
Harmony: average value for harmony link values within the community
ValueComMinWB: average value for the minimum harmony values for every link with web browsing data
ValueComMaxWB: average value for the maximum harmony values for every link with web browsing data
ValueComMinTotal: average value for the minimum harmony values for every link
ValueComMaxTotal: average value for the maximum harmony values for every link
Categories: number of categories visited by the community members
HarmonyMin: absolute minimum value for the minimum harmony values
HarmonyMax: absolute maximum value for the maximum harmony values

With these measures the harmony level within the community is better understood to associate if it is obtained due to the contribution of some similar values or, on the other hand, due to some extreme values in specific nodes. This will help to understand the best approach to use for example in marketing campaigns about who to contact and how to do it.

Apart from improving the understanding, the way of present invention proposes for characterizing communities will help when filtering or selecting groups with specific features.

Finally, relevant categories are added and classified by the harmony level that users share around these categories. The group of users obtains its semantic information and will be perfectly explained in terms of web interests for its members. Thus, the output obtained is a set of metrics that explain how similar the users of the group are and what interests they have in common.

For every active member of a community, the following output is generated according to one embodiment of the invention:

| Name | Description |
|---|---|
| Id_com | Id community |
| MembersCommunity, | Community information, web users |
| MembersWebprof, | of the community, similarity |
| Similaritymaximum, | measures and categories |
| Similarityminimum, {Catx:SUM}, | |
| {Catx:Count} | |

1. A method for characterizing a group of users, related among them by their mobile communication data, according to web navigation data, the method comprising the steps of:
a) building a social graph from the mobile communication data of a user and his contacts;
b) extracting web navigation data of each user of the social graph;
c) associating to each edge linking two users of the social graph, web navigation data extracted for both two users;
d) obtaining a measure of harmony based on comparing web navigation data of both two users; and
e) providing a set of metrics for the group of users based on the measures of harmony of step e), characterizing the group of users.

2. The method according to claim 1 wherein the mobile communication data of a user are obtained from his call detail records.

3. The method according to claim 1 wherein building the social graph from mobile communication data, further comprising weighting a relation between two users according to their call detail records.

4. The method according to claim 1 wherein the web navigation data of a user refer to categories of web content visited by said user.

5. The method according to claim 4, wherein comparing categories between two users further comprising:
assigning a weight distribution according to the subcategories of each category;
comparing each subcategory of the two users; and
providing a value of similarity as a result of the comparison: if two subcategories match, their weights are added; if they are different, their weights are subtracted; and if there is no correspondence for a subcategory in one user, the weight are ignored.

6. The method according to claim 4 wherein the measure of harmony further comprising taking into account the number of categories involved for each user, which may result in a different measure from a user A to a user B than from the user B to the user A, combining both of them to offer a global measure for the relation among users A and B.

7. The method according to claim 1 wherein the set of metrics characterizing the group of users, further comprising at least one of the following: number of users, number of users who browse the Internet, number of users who browse certain websites and a homogeneity degree of users belonging to the group.

8. The method according to claim 1 wherein a user belongs to more than one group.

9. The method according to claim 1, wherein the users are users of a social network, further comprising using social network analysis for determining groups of users.

10. The method according to claim 1, wherein web navigation data of users are obtained from provided profiles of the users.

11. A system for characterizing a group of users, related among them by their mobile communication data, according to web navigation data, the system is characterized by comprising means for building a social graph from the mobile communication data of a user and his contacts; means for extracting web navigation data of each user of the social graph; means for associating to each edge linking two users of the social graph, web navigation data extracted for both two users; means for obtaining a measure of harmony based on comparing web navigation data of both users; and means for providing a set of metrics for the groups of users based on the measures of harmony of step e), characterizing the group of users.

12. A computer program product comprising computer program code adapted to perform the method according to claim 1 when said program code is executed on a computer, a digital signal processor, a field-programmable gate array, an application-specific integrated circuit, a micro-processor, a micro-controller, or any other form of programmable hardware.
